(19) United States
(12) Patent Application Publication
(10) Pub. No.: US 2010/0304253 A1
(43) Pub. Date: Dec. 2, 2010

(54) METHOD OF CONTROLLING A FUEL CELL SYSTEM UTILIZING A FUEL CELL SENSOR

(75) Inventors: Aaron Crumm, Ann Arbor, MI (US); Timothy LaBreche, Ann Arbor, MI (US); Shaowu Zha, Ann Arbor, MI (US)

Correspondence Address: Adaptive Materials Inc., 5500 S. State Rd., Ann Arbor, MI, 48108, US

(73) Assignee: ADAPTIVE MATERIALS, INC., Ann Arbor, MI (US)

(21) Appl. No.: 12/790,500

(22) Filed: May 28, 2010

Related U.S. Application Data
(60) Provisional application No. 61/181,781, filed on May 28, 2009.

(51) Int. Cl. H01M 8/04

(52) U.S. Cl. 429/432

(57) ABSTRACT

A method for controlling a fuel cell system, the fuel cell system is described in accordance with exemplary embodiments. The method includes measuring an open circuit voltage of the fuel cell. The method further includes determining an air actuator control signal based on the open circuit voltage of the fuel cell. The method further includes controlling the air actuator based on the air actuator control signal. The method further includes determining a fuel actuator control signal based on the open circuit voltage of the fuel cell. The method further includes controlling the fuel actuator based on the fuel actuator control signal.

### RELATED APPLICATIONS

This application claims priority to Provisional Application 61/181,781 filed on May 28, 2009 the entire contents of which are hereby incorporated by reference, herein.

### FIELD OF THE INVENTION

The invention relates to a solid oxide fuel cell utilizing an integrated sensor.

### BACKGROUND

The statements in this section merely provide background information related to the present disclosure and may not constitute prior art. Solid oxide fuel cells create an electromotive force across an electrolyte by reacting a fuel, typically hydrogen, at an anode disposed on a first side of the electrolyte, and an oxidant, typically oxygen at a cathode disposed on a second side of the electrolyte. Solid oxide fuel cells can operate utilizing an onboard fuel that is reformed prior to utilization within the fuel cell. Using an onboard fuel is advantageous in that the onboard fuel is easy to transport and in that the reformation process can be utilized to preheat the fuel cell to operate at the fuel cell at desired operating temperatures.

Solid oxide fuel cell systems can control an oxygen-to-fuel ratio at the fuel reforming reactor to efficiently reform the onboard fuel and to prevent coking Typically, fluid flow sensors provide feedback so that air and fuel flow rates can be controlled. However, the fluid flow sensors undesirably raise the cost of the fuel cell system and the fluid flow sensors do not measure air and fuel in close proximity to the solid oxide fuel cell, thereby limiting the precision of control systems utilizing traditional fluid flow sensors.

Therefore, fuel cells with improved sensing methods and components are needed.

### DRAWINGS

FIG. 1 depicts a fuel cell stack in accordance with an exemplary embodiment of the present disclosure;

FIG. 2 depicts a power and signal flow diagram of a fuel cell system in accordance with an exemplary embodiment of the present disclosure;

FIG. 3A depicts a fluid and signal flow diagram of a first embodiment of a fuel cell system;

FIG. 3B depicts a fluid and signal flow diagram of a second embodiment of a fuel cell system;

FIG. 4A and 4B depict flow chart diagrams of an exemplary control scheme in accordance with an exemplary embodiment of the present disclosure;

FIG. 5 depicts a graphical representation of open circuit voltage vs. time during an exemplary air and fuel tuning operation;

FIG. 6 depicts a graphical representation of stack voltage vs. stack current of a first portion of the air and fuel tuning operation depicted in FIG. 5;

FIG. 7 depicts a graphical representation of stack voltage vs. stack current of a second portion of the air and fuel tuning operation depicted in FIG. 5;

FIG. 8 depicts a flow chart diagram of a shutdown control scheme in accordance an exemplary embodiment of the present disclosure; and

FIG. 9 depicts a flow chart diagram of a startup control scheme in accordance with an exemplary embodiment of the present disclosure.

It should be understood that the appended drawings are not necessarily to scale, presenting a somewhat simplified representation of various preferred features illustrative of the basic principles of the invention. The specific design features of the fuel cell as disclosed herein will be determined in part by the particular intended application and use environment. Certain features of the illustrated embodiments have been enlarged or distorted relative to others for visualization and clear explanation. In particular, thin features may be thickened, for example, for clarity of illustration.

### SUMMARY

A method for controlling a fuel cell system is described in accordance with exemplary embodiments. The fuel cell system includes an air actuator, a fuel actuator, and a fuel cell. The fuel cell includes an anode, a cathode, and an electrolyte. The method includes measuring an open circuit voltage of the fuel cell. The method further includes determining an air actuator control signal based on the open circuit voltage of the fuel cell. The method further includes controlling the air actuator based on the air actuator control signal. The method further includes determining a fuel actuator control signal based on the open circuit voltage of the fuel cell. The method further includes controlling the fuel actuator based on the fuel actuator control signal.

### DETAILED DESCRIPTION

Described herein are various embodiments of a fuel cell system and methods for controlling a fuel cell system based on an open circuit voltage of a fuel cell. The fuel cell systems described herein include fuel cell stacks, wherein the open circuit voltage can be detected by a control circuit continuously monitoring one or more cells providing an open circuit voltage level. In an exemplary embodiment, one or more fuel cells can be dedicated to open circuit voltage sensing throughout the life of the fuel cell system. In alternate designs, a control system can command a fuel cell stack so that a fuel cell can be utilized for providing electrical power during certain time periods and can be utilized for open circuit voltage sensing during other time periods.

The disclosure presents an exemplary fuel cell system 10 utilizing exemplary control schemes. However, it is to be understood that aspects of the control schemes and strategies described herein can be applied to systems utilizing other types of sensors and other types of actuators. Alternate control schemes may substitute an actuator described herein for another type of actuator, while being within the scope and spirit of the disclosure. For example, one or more of a pump, a valve, or a blower may be substituted for the blowers and valves described herein. The term (‘actuator,’) as used herein, refers to a component that a control system 20 can command to affect operation of the fuel cell system 10 by modifying, for example, a fluid flow rate or a power attribute.

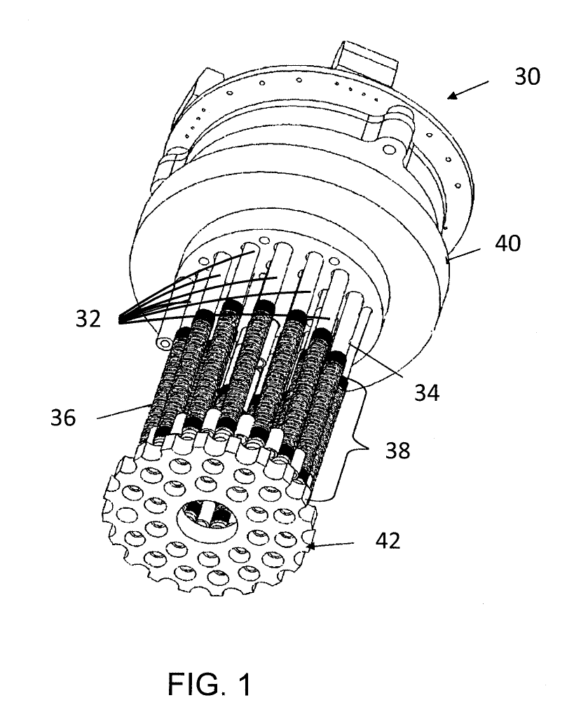

FIG. 1 depicts an exemplary fuel cell stack 30 of the fuel cell system 10. The fuel cell stack 30 includes fuel cell tubes 32, a sensing cell 34, a manifold 40, an end piece 42, and a current conducting system 36 electrically interconnecting the fuel cell tubes 32 and routing current away from the sensing cell 34.

The current collection system 36 is electrically connected to the sensing cell 34 through an anode current collector and a cathode current collector that route current away from the sensing cell 34 without interconnecting the sensing cell 34 with other fuel cell tubes 32. Since the sensing cell 34 is detecting open circuit voltage and not configured to route substantial levels of electric current from the sensing cell 34, the sensing cell 34 can include much less current conduction material then each one of the fuel cell tubes 32. In an exemplary fuel cell stack 30, the fuel cells tubes 32 are arranged in a series connection to produce DC power at a voltage which is a sum of the potential of the individual fuel cells. Alternatively, fuel cell electrodes can be connected in parallel or in a combination with some electrodes connected in series and some electrodes in parallel.

The fuel cell tubes 32 and the sensing cell 34 each comprise a substantially similar construction and each include the active portion 38 having an inner anode layer, an exterior cathode layer, and an electrolyte disposed therebetween. The active portion 38 utilizes air and fuel to generate electromotive force across the electrolyte, thereby motivating electric current.

In an exemplary embodiment, the fuel cell tubes 32 and the sensing cell 34 are advantageously relatively light in weight, and provide good power density to mass ratios. Exemplary tubes comprise a 1 mm-20 mm diameter tube. Thin, lightweight tubes are also advantageous in that the tubes hold less heat, allowing the fuel cell to be heated rapidly. Other material combinations for the anode, electrolyte and cathode, as well as other cross section geometries (triangular, square, polygonal, etc.) will be readily apparent to those skilled in the art given the benefit of this disclosure.

In general, the anode layer and the cathode layer are formed of porous materials capable of functioning as an electrical conductor and capable of facilitating the appropriate reactions. The porosity of these materials allows dual directional flow of gases (e.g., to admit the fuel or oxidant gases and permit exit of the byproduct gases). In an exemplary embodiment, the anode comprises a conductive metal such as nickel, disposed within a ceramic skeleton, such as yttria-stabilized zirconia. The cathode layer comprises a conductive material chemically stable in an oxidizing environment. In an exemplary embodiment, the cathode layer comprises a perovskite material and specifically lanthanum strontium cobalt ferrite. In an alternative exemplary embodiment, the cathode layer comprises lanthanum strontium manganite (LSM).

The electrolyte layer comprises a dense layer substantially preventing molecular transport, therethrough. Exemplary materials for the electrolyte layer include zirconium-based materials and cerium-based materials such as yttria-stabilized zirconia and gadolinium doped ceria, and can further include various other dopants and modifiers to affect ion conducting properties.

Each of the fuel cell tubes 32 further include a fuel feed tube (not shown) and a fuel reforming reactor (not shown) disposed therein. The fuel reforming reactors are disposed within fuel feed tubes and the fuel feed tubes are disposed within each of the fuel cell tubes 32 and within the sensing cell, such that each fuel reforming reactor is positioned upstream from (as defined by flow of fuel gas) and proximate to active portions 38 of the fuel cell tubes 32 and of the sensing cell 34. The fuel reforming reactor reforms hydrocarbon fuel to hydrogen by catalyzing a partial oxidizing reaction between the hydrocarbon and oxygen. In an exemplary embodiment, the fuel reforming reactor comprises a supported catalyst. The supported catalysts includes very fine scale catalyst particles supported on a substrate. The catalyst can comprise, for example, particles of a suitable metal such as platinum or other noble metals such as palladium, rhodium, iridium, osmium, or their alloys and the substrate can comprise oxides (such as aluminum oxide), carbides, and nitrides.

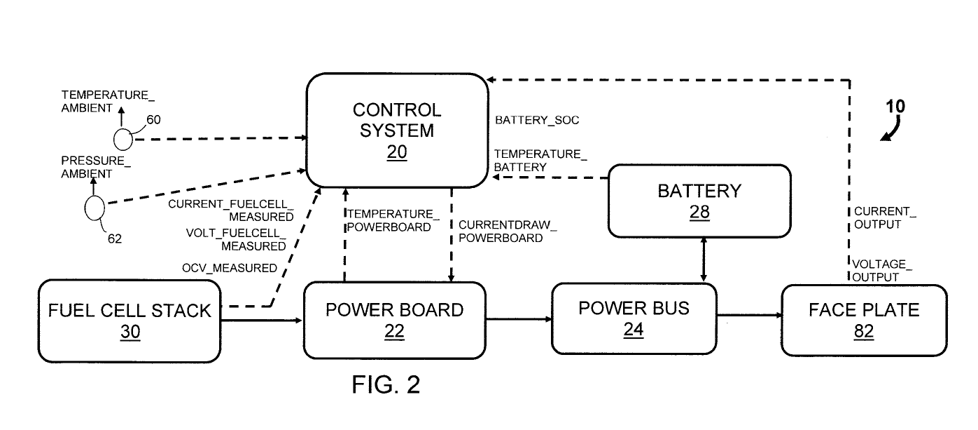

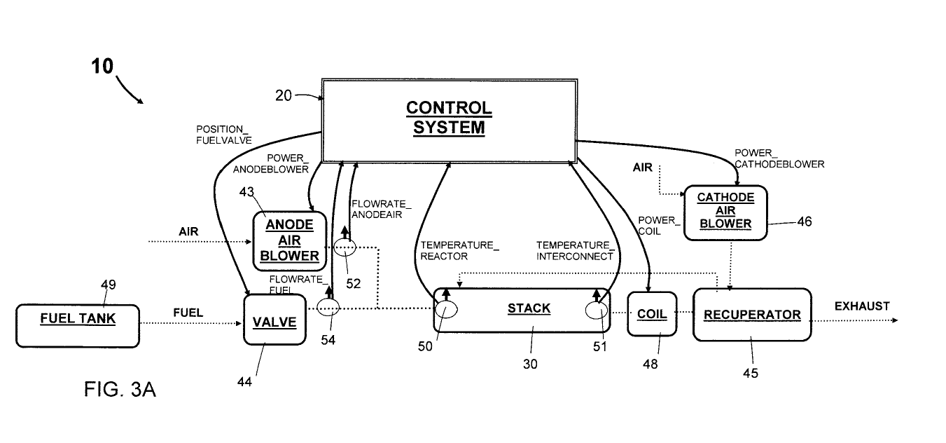

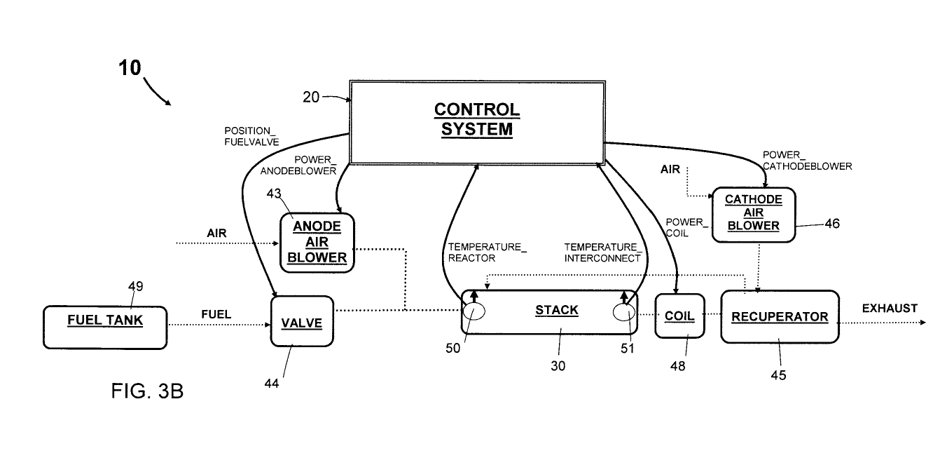

Referring to FIGS. 2, 3A, and 3B, FIG. 2 depicts a power and signal flow diagram of the fuel cell system 10, and FIG. 3A and FIG. 3B depict fluid and signal flow diagrams of the fuel cell system 10 and a fuel cell system 10′. Components of the fuel cell systems 10, 10′ depicted in FIGS. 2, 3A, and 3B include the fuel cell stack (‘FUEL CELL STACK’) 30 along with the control system (‘CONTROL SYSTEM’) 20, a power board (‘POWER BOARD) 22, a power bus (‘POWER BUS’) 24, a battery (‘BATTERY’) 28, a faceplate (‘FACE PLATE’) 82, an ambient temperature sensor 60, a pressure sensor 62, a fuel tank (‘FUEL TANK’) 49, a fuel valve 44 (‘VALVE’), an anode air blower (‘ANODE AIR BLOWER’) 43, a (‘RECUPERATOR’) 45, a cathode air blower (‘CATHODE AIR BLOWER’) 46, and a heating coil (‘COIL’) 48. In a first embodiment depicted in FIG. 3A, the fuel cell system 10, includes an anode air flow rate sensor 52 and a fuel flow sensor 54, wherein in a second embodiment, the fuel cell system 10′ (FIG. 3B) does not include the air flow rate sensor 52 and the fuel flow rate sensor 54.

The control system 20 comprises a microprocessor configured to execute a set of control algorithms comprising resident program instructions and calibrations stored in storage mediums to provide the respective control functions. The control system 20 can monitor input signals from sensors disposed throughout the fuel cell systems 10, 10′ some of which are described in detail herein below and can execute algorithms in response to the monitored input signals to execute routines to control power flows and component operations of the fuel cell systems 10, 10′.

The control system 20 detects a current level (‘CURRENT_FUELCELL_MEASURED’) and a voltage level (‘VOLT_FUELLCELL_MEASURED’), and an open circuit voltage level (OCV_MEASURED) from the fuel cell stack 30. In an exemplary embodiment, a current level from the sensing cell 34 is measured to provide the open circuit voltage level. In an alternate embodiment open circuit voltages can be provided by fuel cells of the fuel cell stack during operating conditions when power is not being drawn from the fuel cell stack 30 by the power board 22.

The power board 22 provides voltage conversion between the fuel cell stack 30 voltage and the primary system voltage and the level of current the power board draws from the fuel cell stack 30 can be adjusted by commands (CURRENTDRAW_POWERBOARD) from the control system 20. Further, the control system 20 monitors a temperature (‘TEMPERATURE_POWERBOARD’) from temperature sensor (not shown) of power board 22.

The power bus 24 comprises an electrically conductive network configured to route power from the energy conversion devices (the rechargeable battery 28 and the fuel cell stack 30) to the face plate 32. The face plate 82 comprises a plurality of power ports for connecting external devices to the fuel cell systems 10, 10′.

The exemplary rechargeable battery 28 is a rechargeable battery configured to receive power from the power bus 24 and to discharge power to the power bus 24. The rechargeable battery 28 can comprise any of several rechargeable battery technologies including, for example, nickel-cadmium, nickel-metal hydride, lithium-ion, and lithium-sulfur technologies. In alternative embodiments, other reversibly energy storage technologies such as ultra-capacitors can be utilized in addition to or instead of the rechargeable battery 28. Further, in alternate embodiments, multiple energy storage devices can be utilized within fuel cell systems 10, 10′. The control system 20 receives information from internal sensors within the battery 28 monitoring battery state of charge (‘BATTERY_SOC’) and temperatures (‘TEMPERATURE_BATTERY’) at varied locations of the battery 28.

The fuel tank 49 contains a fuel for use by the fuel cell stack 30. Exemplary fuels include a wide range of hydrocarbon fuels. In an exemplary embodiment, the fuel comprises an alkane fuel and specifically, propane fuel. In alternative embodiments, the fuel can comprise one or more other types of alkane fuel, for example, methane, ethane, propane, butane, pentane, hexane, heptane, octane, and the like, and can include non-linear alkane isomers. Further, other types of hydrocarbon fuel, such as partially and fully saturated hydrocarbons, and oxygenated hydrocarbons, such as alcohols and glycols, can be utilized as fuel that can be converted to electrical energy by the fuel cell stack 30. The fuel also can include mixtures comprising combinations of various component fuel molecules examples of which include gasoline blends, liquefied natural gas, JP-8 fuel and diesel fuel.

Other signals monitored by the control system 20 include fuel flow rate (‘FLOWRATE_FUEL’) from the fuel flow rate sensor 54 (fuel cell system 10), an anode air flow rate (‘FLOWRATE_ANODEAIR’) from anode air flow rate sensor 52 (fuel cell system 10), a reactor temperature (‘TEMPERATURE_REACTOR’) from a temperature sensor 50 proximate fuel reforming reactors of the fuel cell stack 30, and an interconnect temperature (‘TEMPERATURE_INTERCONNECT’) from a temperature sensor 51 disposed proximate interconnect members of the fuel cell stack 30. The control system 20 is configured to provide signals to send commands to component actuators of the fuel cell stack 30. The signals include a fuel valve position (‘POSITION_FUELVALVE’), an anode air blower power level (‘POWER_ANODEBLOWER’), a coil power level (‘POWER_COIL’), and a cathode air blower power level (‘POWER_CATHODEBLOWER’).

The cathode air blower 46 moves ambient air through the recuperator 45 and into the fuel cell stack 30 and an exhaust fan (not shown) pulls exhaust gases (‘EXHAUST’) away from the fuel cell stack 30. The fuel valve 44 controls fuel flow from the fuel tank 49 into the fuel cell stack 30 and the anode air blower 43 moves ambient air into the fuel cell stack 30, wherein the ambient air and fuel are combined and reacted within the fuel reforming reactors. The coil 48 comprises a resistant heating coil 48 that can heat fuel and air that pass through the fuel cell stack 30 to combust the air and fuel.

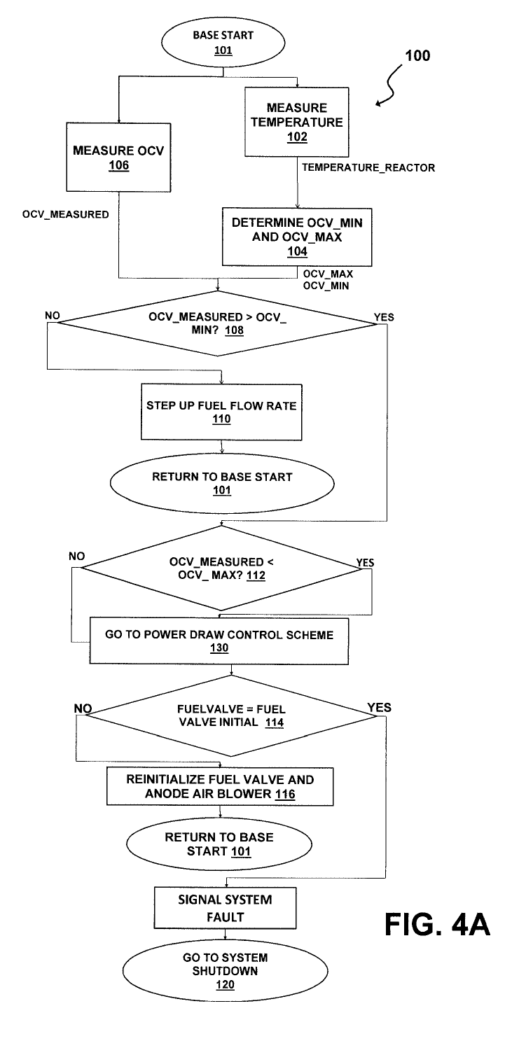

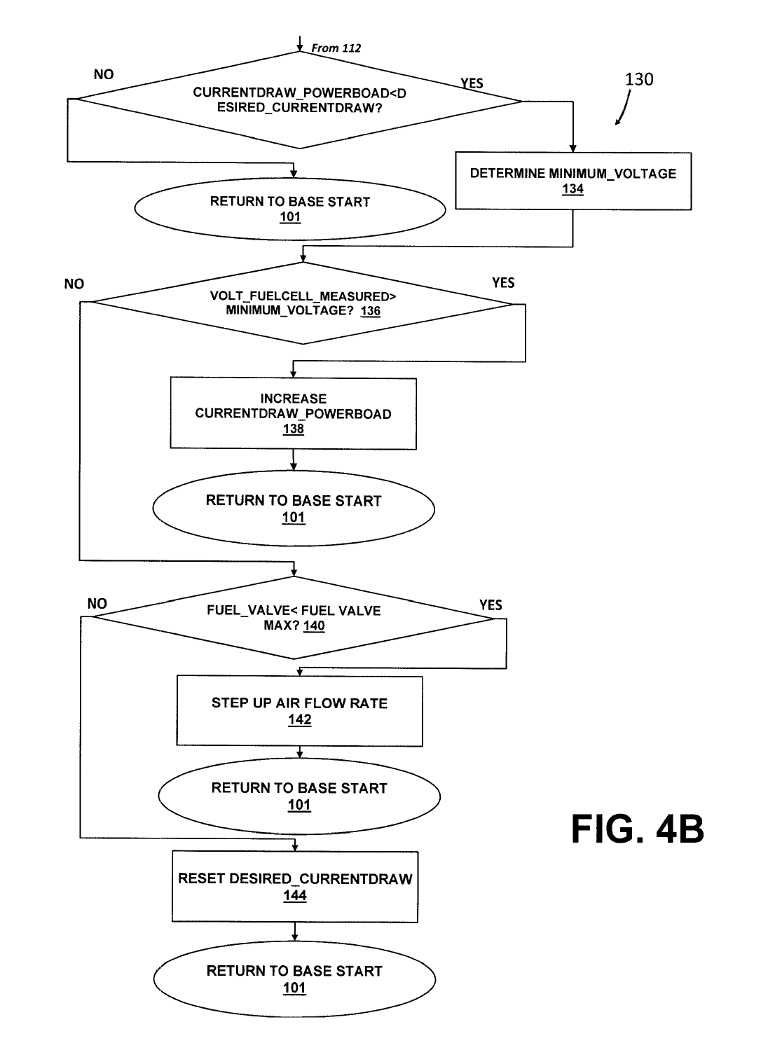

Referring to FIGS. 4A and 4B a base control scheme 100 is utilized by the control system 20 to control components the fuel cell systems 10, 10′. The control system 20 operates utilizing the base control scheme 100 during normal steady-state operation. In particular, the control system 20 utilizes the base control scheme 100 when the control system 20 has completed startup operations in which the fuel cell stack 30 is heated to a steady state of operating temperature (for example, between 700-1,000 degrees Celsius).

At base control start step 101, the control system 20 initializes the control scheme 100. The control system 20 receives reactor temperature measurements (102) from the temperature sensor 50 (TEMPERATURE_REACTOR) and utilizes the reactor temperature measurements to calculate a desired open circuit voltage range (104) between a minimum desired open circuit voltage (‘OCV_MIN’) and a maximum desired open circuit voltage (‘OCV_MAX’) correlating to a desired fuel-to-air ratio lower limit and a desired fuel-to-air ratio upper limit, respectively. Further, the open circuit voltage level measured from the fuel cell 30 (106) is compared to the minimum desired open circuit voltage level (‘OCV_MIN’) (step 108). If the open circuit voltage is greater than the minimum desired open circuit voltage, the control system 20 proceeds to step 112. If the open circuit voltage is not greater than the minimum desired open circuit voltage, the control system proceeds to step 110.

At step 110, the control system 20 increases the target fuel flow rate by commanding the fuel valve 44 to increase fuel flow rate therethrough, and control system 20 subsequently returns to the base control start 101.

At step 112, the control system 20 determines whether the open circuit voltage is less than the maximum desired open circuit voltage. If the open circuit voltage is less than the maximum desired open circuit voltage, the control system 20 proceeds to the current draw control scheme 130. If the measure open circuit voltage is not less than the maximum desired open circuit voltage, the control system proceeds to step 114.

The power draw control scheme 140 (FIG. 4B), controls power draw from the fuel cell stack 30, wherein in the control system 20 determines whether electric current level of the fuel cell stack 30 is less than a desired electric current level (132). If the electric current level is less than the desired electric current level, the control system 20 proceeds to step 134. If current draw is not less than the desired electric current level the control system 20 returns to base control start 101.

At step 134, the control system 20 determines a minimum voltage based on the electric current level of the fuel cell stack 30. At step 136, the control system 20 determines whether the voltage level of the fuel cell stack 30 is greater than the minimum voltage. If the voltage level of the fuel cell stack 30 is greater than the minimum voltage, the control system 20 proceeds to step 138, and the electric current level of the fuel cell stack 30 and then returns to base start 101. If the measured voltage is not greater than the minimum voltage, the control system 20 proceeds to step 140.

At step 140, the control system 20 determines whether the fuel flow rate based on the fuel valve is less than a maximum fuel flow rate (‘FUEL_VALVE_MAX’). If the fuel flow rate is less than a maximum fuel flow rate, the control system 20 will step up the air flow rate 142 and subsequently return to base start 101. If the control system 20 determines the fuel flow rate is not less than the maximum fuel flow rate, the control system 20 will set the desired current level to the current level of the fuel cell stack 30 and the control system 20 returns to the base start 101.

It is to be noted that although fuel flow rate is checked by the control system 20 at step 140, air flow rate is modified by the control system 20 at step 142, wherein fuel flow rate can thereby be modified in the next control loop after the control system 20 returns to base start 101.

At step 114, the control system 20 determines fuel flow rate is at an initial fuel value by determining whether the fuel valve position is equal to an initial valve position value (‘FUEL_VALVE_INITIAL’). If the fuel flow rate is at the initial fuel flow rate value, the control system 20 proceeds to step 116. If the fuel flow rate is not at the initial fuel flow rate value, the control system proceeds to step 118. At step, 116, the control system reinitializes the fuel flow rate and an anode air flow rate and then returns to initialization step 101. The initial fuel flow rate and the initial anode air flow rate provide fuel and air flow rates that are below the desired fuel-to-air ratio range, but provide a fuel-to-air ratio that contributes to stable operation of the fuel cell stack 30, wherein the fuel and air can be tuned from the initial fuel flow rate and initial air flow rate, respectively, to provide a desired fuel-to-air ratio.

At step 118, the control system 20 generates a signal indicating a system fault and enters a system shutdown mode (120).

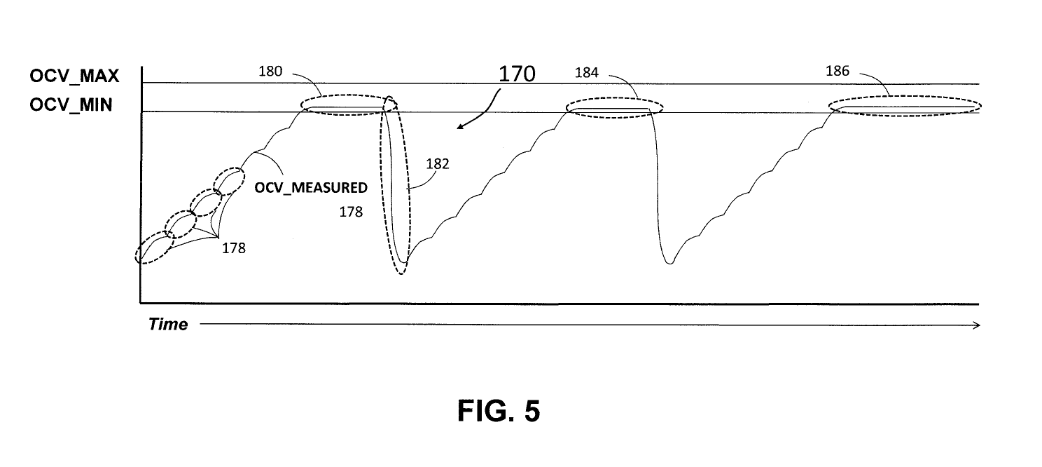

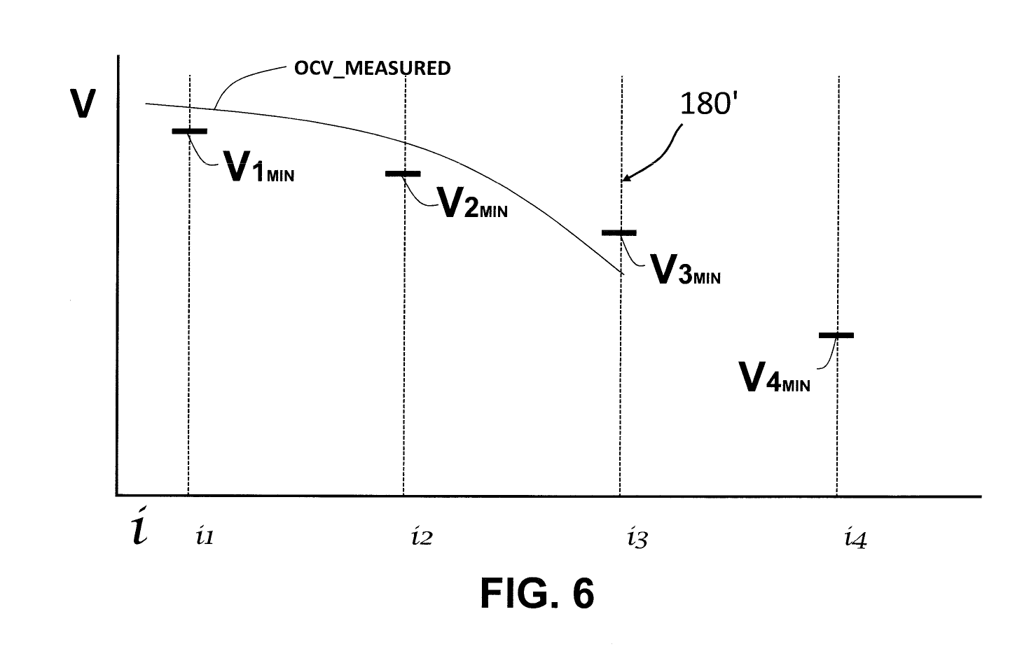

Referring to FIG. 5, a graph 180′ depicts open circuit voltage level over time as the control scheme is operating in the base operating mode 100. The open circuit voltage step up levels (178) are indicative of the open circuit voltage increasing in response to increases in fuel flow to the fuel cell stack 30 in response to the control system 20 executing the step 118. As shown in the portion 180 of the graph 170, when the voltage is within the desired open circuit voltage range (between the minimum and maximum open circuit voltage level,) the control system 20 proceeds to the power draw control scheme 130, the consequences of which are illustrated in the voltage (‘V’) versus electric current (‘i’) graph 180′ of FIG. 6. When electric current draw from the fuel cell stack 30 increases from i₁ to i₄, voltage of the fuel cell stack 30 decreases. At each electric current interval iᵢ, i₂, . . . , the electric current is compared to a minimum voltage V₁ₘᵢₙ, V₂ₘᵢₙ, . . . , and the control system 20 continues to increase current draw from the fuel cell stack 30 until either the desired current is reached or until a minimum voltage is transgressed. During the time frame depicted in portion 182 of FIG. 5 and graph 182′ of FIG. 6, at the third electric current interval i3, the measured voltage falls below the minimum voltage, wherein the control system 20 subsequently confirms that the maximum fuel flow rate has not been reached (step 140), and then steps up the air flow rate (step 142). When air flow rate increases, open circuit voltage decreases (as depicted by portion 182 of graph 170 in FIG. 5), and the control system 20 begins stepping up fuel flow rate to meet the desired open circuit voltage range (depicted by portion 184).

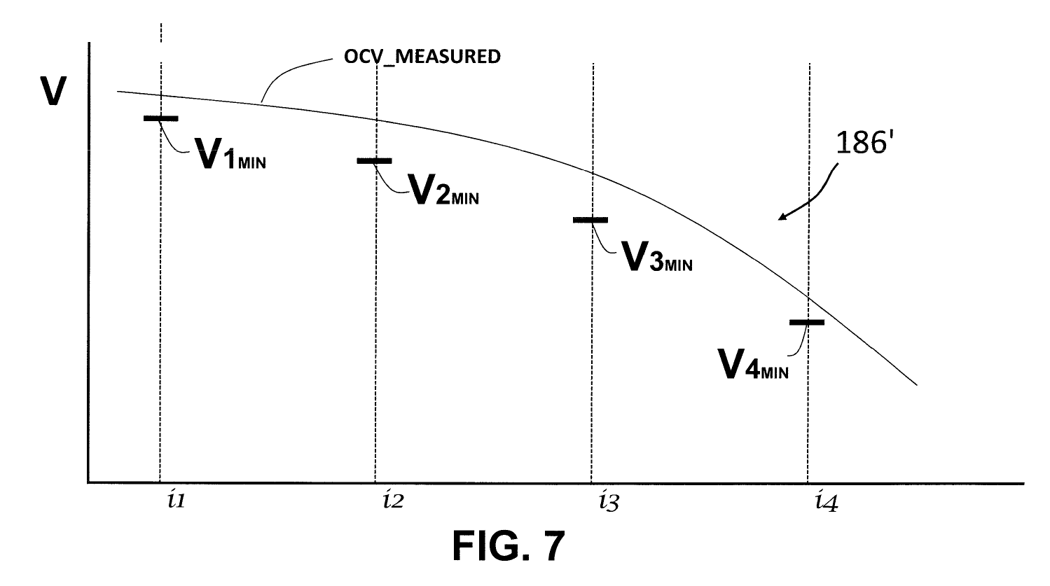

The portion 186 of graph 170 in FIG. 5 and the graph 186′ of FIG. 7 depict operation of the fuel cell system 10 wherein the fuel flow rate has stepped up to a level, wherein the desired current level is provided by the fuel cell stack 30 without transgressing the minimum voltage levels.

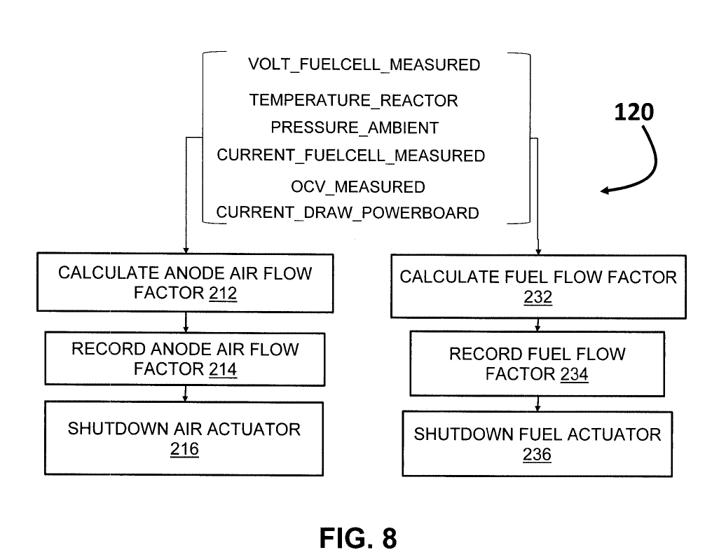

FIG. 8 depicts a shutdown control scheme 120. At step 212, the control system 20 calculates an air flow factor. The air flow factor provides calibration for changes in behavior of the anode air blower 43 over time, thereby allowing accurate open loop control of the anode air blower 43 when the temperature of the fuel cell stack 30 is below a threshold temperature in which the sensing cell 34 does not generate a detectible open circuit voltage. Each of the air flow factor calculation 212 and the fuel flow factor calculation 232 utilize the measured fuel cell voltage, the reactor temperature, the ambient pressure, the current level of the fuel cell stack 30, the open circuit voltage level, and the current draw command from the power board 22 to determine an anode air flow factor and a fuel flow factor, respectively. Each of the anode air flow factor and the fuel flow factor are recorded on memory (214 and 234) prior to shutting down the anode air blower (216) and fuel valve (236).

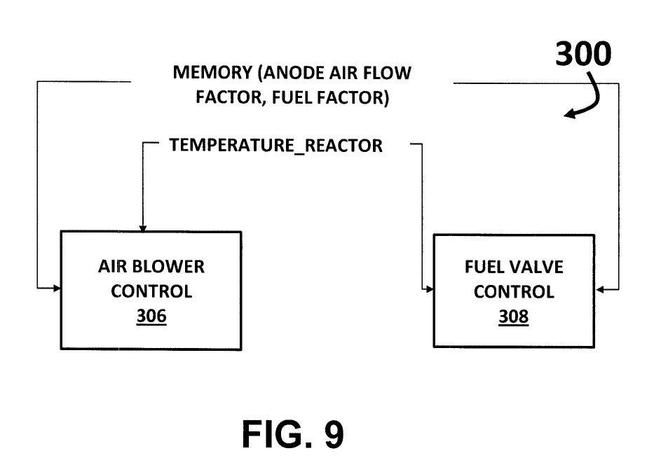

Referring to FIG. 9 a startup control scheme 300 is depicted. During the startup, the control system 20 controls the anode air blower 43 based on the anode air flow factor and the reactor temperature (306), and the control system 20 controls the fuel valve 44 based on the controlled based on the fuel flow factor and the reactor temperature (308).

The exemplary embodiments shown in the figures and described above illustrate, but do not limit, the claimed invention. It should be understood that there is no intention to limit the invention to the specific form disclosed; rather, the invention is to cover all modifications, alternative constructions, and equivalents falling within the spirit and scope of the invention as defined in the claims. Therefore, the foregoing description should not be construed to limit the scope of the invention.

1. A method for controlling a fuel cell system, the fuel cell system comprising an air actuator, a fuel actuator, and a fuel cell comprising an anode, a cathode, and an electrolyte, the method comprising:
measuring an open circuit voltage of the fuel cell;
determining an air actuator control signal based on the open circuit voltage of the fuel cell;
controlling the air actuator based on the air actuator control signal;
determining a fuel actuator control signal based on the open circuit voltage of the fuel cell; and
controlling the fuel actuator based on the fuel actuator control signal.

2. The method of claim 1, further comprising:
measuring a fuel cell temperature level;
determining the air actuator signal based on the fuel cell temperature level; and
determining the fuel actuator control signal based on the fuel cell temperature level.

3. The method of claim 1, further comprising:
measuring ambient pressure;
determining the air actuator signal based on the ambient pressure; and
determining the fuel actuator control signal based on the ambient pressure.

4. Calculating a desired open circuit voltage range based on temperature; and modifying the controlling air flow rate and fuel flow rate to attain an open circuit voltage within the desired open voltage range.

5. The solid oxide fuel cell of claim 4, further comprising ramping up current draw from the fuel cell when the open circuit voltage within the open circuit voltage range is obtained;
monitoring a stack voltage when ramping up power draw;
wherein current is ramped up to a predetermined current level when stack voltage is maintained above a threshold stack voltage; and
wherein an air flow rate and a gas flow rate are increased when stack voltage decreases below a threshold stack voltage.

6. The method of claim 1, further comprising detecting an open current voltage below a desire open circuit voltage lower limit of the open circuit voltage range and
increasing the fuel flow rate when the open current voltage is below the desired open circuit voltage lower limit.

7. The method of claim 1, further comprising detecting an open current voltage above an open circuit voltage upper limit of the desired open circuit voltage range; and
reinitializing anode air flow rate and cathode air flow rate when the open circuit voltage is above the open circuit voltage limit.

8. The method of claim 1, further comprising:
determining an air actuator control signal and a fuel actuator control signal;
determining an air actuator calibration factor based on a stack voltage, an air actuator signal, and a stack current; and
transitioning the fuel cell stack to a shutdown mode.

9. The method of claim 8, further comprising:
accessing an air actuator calibration factor from stored memory; and
determining an air actuator signal based on the air actuator calibration factor.

10. The method of claim 1 further comprising:
determining a fuel actuator calibration factor based on the stack voltage, the air actuator signal, and the stack current; and
determining a fuel actuator control signal and a fuel actuator control signal;
determining an air actuator calibration factor based on a stack voltage, an air actuator signal, and a stack current; and
transitioning the fuel cell stack to a shutdown mode.

11. The method of claim 10, further comprising:
accessing a fuel actuator calibration factor from stored memory; and
determining the fuel actuator signal based on the fuel actuator calibration factor.

12. A method for controlling a fuel cell system, the fuel cell system comprising a sensing fuel cell, a fuel cell stack, an air actuator delivering air to the fuel cell stack and a fuel actuator, and a fuel cell comprising an anode, a cathode, and an electrolyte, the method comprising:
measuring an open circuit voltage of the sensing fuel cell;
determining an air actuator control signal based on the open circuit voltage of the sensing fuel cell;
controlling the air actuator based on the air actuator control signal;
determining a fuel actuator control signal based on the open circuit voltage of the fuel cell; and
controlling the fuel actuator based on the fuel actuator control signal.

13. The method of claim 12, further comprising:
measuring a fuel cell temperature of the sensing fuel cell;
determining the air actuator signal based on the sensing fuel cell temperature; and
determining the fuel actuator control signal based on the sensing fuel cell temperature.

14. The method of claim 12, further comprising calculating a desired open circuit voltage range based on temperature; and modifying the controlling air flow rate and fuel flow rate to attain an open circuit voltage within the desired open voltage range.

15. The solid oxide fuel cell of claim 12, further comprising ramping up current drawn from the fuel cell when the open circuit voltage within the open circuit voltage range is obtained;
monitoring the fuel cell stack voltage when ramping up power draw;
wherein current is ramped up to a predetermined current level when stack voltage is maintained above a threshold stack voltage; and
wherein an air flow rate and a gas flow rate are increased when stack voltage decreases below a threshold stack voltage.

16. The method of claim 12, further comprising:
detecting an open current voltage below a desire open circuit voltage lower limit of the open circuit voltage range and
increasing the fuel flow rate when the open current voltage is below the desired open circuit voltage lower limit.

17. The method of claim 1, further comprising detecting an open current voltage above an open circuit voltage upper limit of the desired open circuit voltage range; and
reinitializing anode air flow rate and cathode air flow rate when the open circuit voltage is above the open circuit voltage limit.

18. A method for controlling a fuel cell system, the fuel cell system comprising an fluid flow sensor, an air actuator, a fuel actuator, and a fuel cell comprising an anode, a cathode, and an electrolyte, the method comprising:
measuring an open circuit voltage of the fuel cell;
determining an actuator control signal based on the open circuit voltage of the fuel cell;
controlling the actuator based on the actuator control signal;

19. The method of claim 18, further comprising:
detecting a fault in the fluid flow sensor and
controlling the actuator based on the actuator control signal when the fault in the fluid flow sensor is detected.

20. The method of claim 18 further comprising:
monitoring a signal form the fluid flow sensor and
determining an actuator control signal based on the open circuit voltage of the fuel cell and the fluid flow sensor signal.
